(19) United States
(12) Patent Application Publication
(10) Pub. No.: US 2025/0295975 A1
(43) Pub. Date: Sep. 25, 2025

(54) CALCULATE FASTEST SET UP USING PACE OF PLAY

(71) Applicant: Textron Inc., Providence, RI (US)

(72) Inventor: Brian David Wanta, North Augusta, SC (US)

(73) Assignee: Textron Inc., Providence, RI (US)

(21) Appl. No.: 18/614,561

(22) Filed: Mar. 22, 2024

(51) Int. Cl. A63B 71/06; A63B 57/00; A63B 69/36

(52) U.S. Cl. CPC A63B 71/0686; A63B 69/3691; A63B 57/505; A63B 2220/62

(57) ABSTRACT

A pace of play system for a golf course includes one or more processing circuits. The one or more processing circuits are configured to acquire one or more current or planned tee positions for one or more tees associated with one or more holes of the golf course, acquire one or more current or planned pin positions for one or more pins associated with the one or more holes, and estimate a current pace of play for a current setup of the golf course based on the one or more current or planned tee positions and the one or more current or planned pin positions.

### BACKGROUND

Pace of play is an important statistic for a golf course to accurately determine and monitor. Knowledge of pace of play helps identify groups of golfers that are playing slow and facilitate taking corrective actions, facilitate tee-sheet optimization, etc. to make the golf course more efficient, more profitable, and, overall, more enjoyable for the golfers. However, current pace of play detection and monitoring strategies do not provide golf course management with efficient and accurate ways to use this information to achieve a specific desired pace of play or to optimize a layout of the golf course to achieve the desired pace of play, which can thereby impact efficiency, profitability, and golfer enjoyment of the golf course.

### SUMMARY

One embodiment relates to a pace of play system for a golf course. The pace of play system includes one or more processing circuits. The one or more processing circuits are configured to acquire one or more current or planned tee positions for one or more tees associated with one or more holes of the golf course, acquire one or more current or planned pin positions for one or more pins associated with the one or more holes, and estimate a current pace of play for a current setup of the golf course based on the one or more current or planned tee positions and the one or more current or planned pin positions.

Another embodiment relates to a pace of play system for a golf course. The pace of play system includes one or more processing circuits. The one or more processing circuits are configured to acquire one or more current or planned tee positions for one or more tees associated with one or more holes of the golf course, acquire one or more current or planned positions for one or more pins associated with the one or more holes, estimate a current pace of play for a current setup of the golf course based on the one or more current or planned tee positions and the one or more current or planned pin positions, acquire a desired pace of play for the golf course, and generate a new setup for the golf course to substantially provide the desired pace of play by providing at least one of (a) a new tee position for at least one of the one or more tees or (b) a new pin position for at least one of the one or more pins to achieve the desired pace of play. The new setup is based on at least one of (a) a play history of golfers included on an upcoming tee-sheet for the golf course, (b) past setups of the golf course, (c) past environmental conditions for the past setups, or (d) current or predicted environmental conditions during play on the new setup.

Still another embodiment relates to a pace of play system for a golf course. The pace of play system includes one or more processing circuits. The one or more processing circuits are configured to acquire one or more current or planned tee positions for one or more tees associated with one or more holes of the golf course, acquire one or more current or planned pin positions for one or more pins associated with the one or more holes, and estimate a current pace of play for a current setup of the golf course based on the one or more current or planned tee positions, the one or more current or planned pin positions, past setups of the golf course, past environmental conditions for the past setups, and current or predicted environmental conditions during play on the current setup.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a schematic block diagram of a site monitoring and control system including a plurality of the vehicles of FIG. 1, according to an exemplary embodiment.

FIG. 4 is a schematic view of a portion of a golf course, according to an exemplary embodiment.

FIG. 5 is a flow diagram of a method for determining pace of play for a round of golf, according to an exemplary embodiment

FIG. 6 is a flow diagram of a method for determining a configuration for a setup of a golf course to achieve a desired pace of play, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

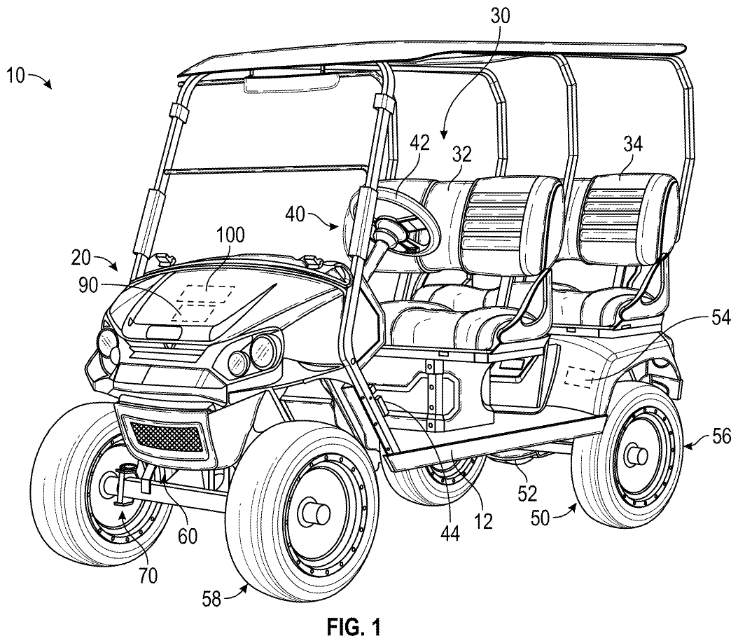

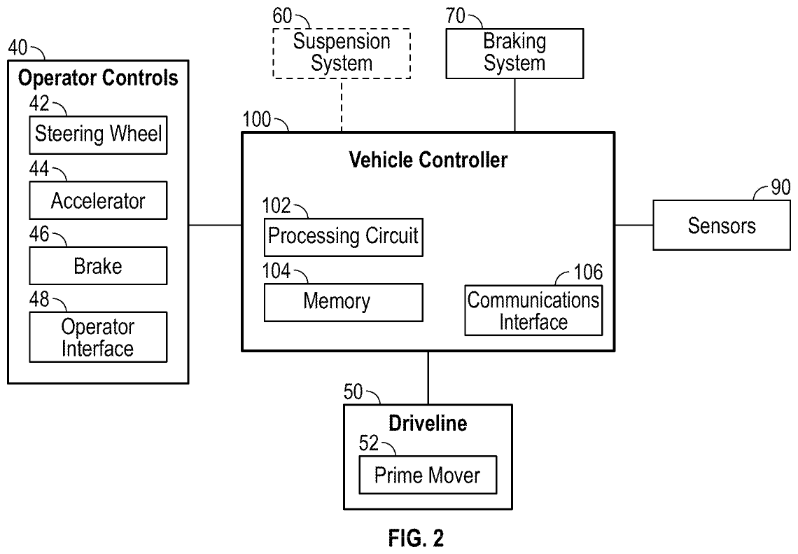

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a vehicle control system, shown as vehicle controller 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart, an all-terrain vehicle (“ATV”), a utility task vehicle (“UTV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle controller 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle controller 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle controller 100 may represent a collection of processing devices. In such cases, the processing circuit 102 represents the collective processors of the devices, and the memory 104 represents the collective storage devices of the devices.

In one embodiment, the vehicle controller 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle controller 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle controller 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Site Monitoring and Control System

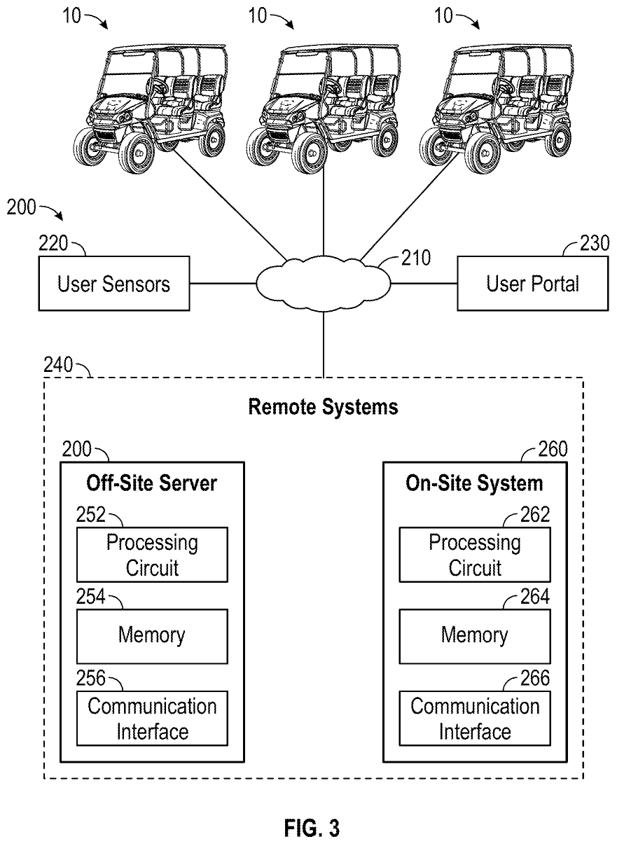

As shown in FIG. 3, a monitoring and control system, shown as site monitoring and control system 200, includes one or more vehicles 10; one or more second sensors, shown as user sensors 220, positioned remote or separate from the vehicles 10; an operator interface, shown as user portal 230, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, hear rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons braking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). The user portal 230 may be or may be accessed via a computer, laptop, smartphone, tablet, or the like.

As shown in FIG. 3, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 3, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle controllers 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Pace of Play Estimation and Optimization

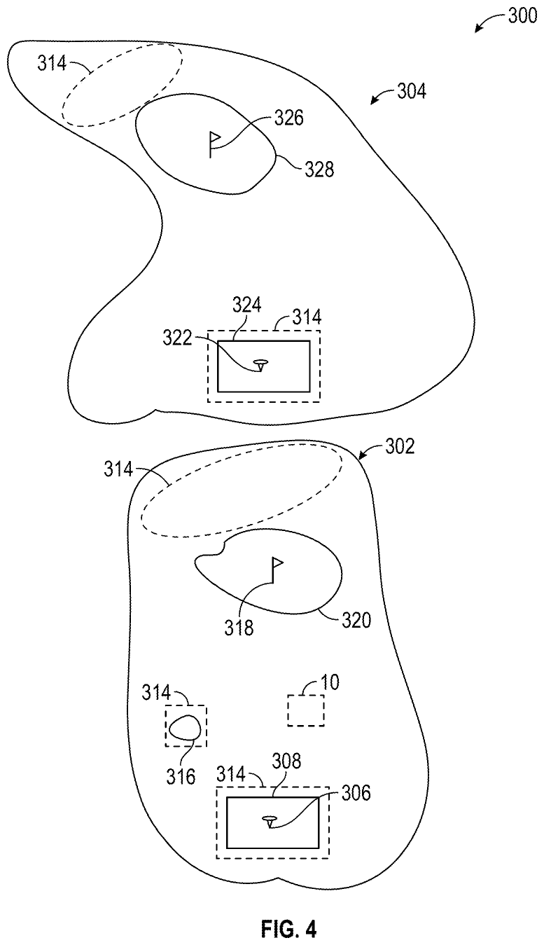

According to an exemplary embodiment, the site monitoring and control system 200, including the vehicle controller 100, the user sensors 220, the user portal 230, and the remote systems 240 (which may be referred to herein as a “pace of play monitoring, reporting, estimation, and/or optimization system”), is configured to facilitate improving or enhancing the prediction and generation of a golf course setup (e.g., layout, setup, etc.) to achieve a desired pace of play of golfers on a hole-by-hole basis and/or on a round-by-round basis. Further, it should be understood that any of the functions or processes described herein with respect to the site monitoring and control system 200 may be performed by the vehicle controller 100 and/or the remote systems 240. By way of example, data collection may be performed by the vehicle controller 100 and data analytics may be performed by the vehicle controller 100. By way of another example, data collection may be performed by the vehicle controller 100 and data analytics may be performed by the remote systems 240. By way of yet another example, data collection may be performed by the vehicle controller 100, a first portion of data analytics may be performed by the vehicle controller 100, and a second portion of data analytics may be performed by the remote systems 240. By way of still another example, a first portion of data collection may be performed by the vehicle controller 100, a second portion of data collection may be performed by the remote systems 240, and data analytics may be performed by the vehicle controller 100 and/or the remote systems 240. The pace of play driven golf course optimization will be described herein in the context of FIGS. 4-6.

As shown in FIG. 4, the golf course 300 includes one or more holes, shown as first hole 302 and second hole 304. The first hole 302 of the golf course 300 includes a tee, shown as first tee 306, a tee box, shown as first tee box 308, a plurality of geofences, shown as geofences 314, one or more hazards (e.g., a water hazard, woods, fescue, non-playable area, area under repair, etc.), shown as hazard 316, a pin, shown as first pin 318, the vehicle 10, and a green, shown as first green 320. The geofences 314 include a tee box geofence surrounding the first tee box 308, a green geofence proximate the first green 320, and/or a hazard geofence (e.g., a geofence 314 surrounding the hazard 316, etc.). The second hole 304 of the golf course 300 includes a tee, shown as second tee 322, a tee box, shown as second tee box 324, the geofences 314, a pin, shown as second pin 326, and a green, shown as a second green 328. In other embodiments the golf course 300 includes more than two holes (e.g., a nine-hole course, an eighteen-hole course, etc.), more than two tees, more than two pins, more than two putting greens, more than one hazard, more than two tee boxes, and more than one vehicle 10.

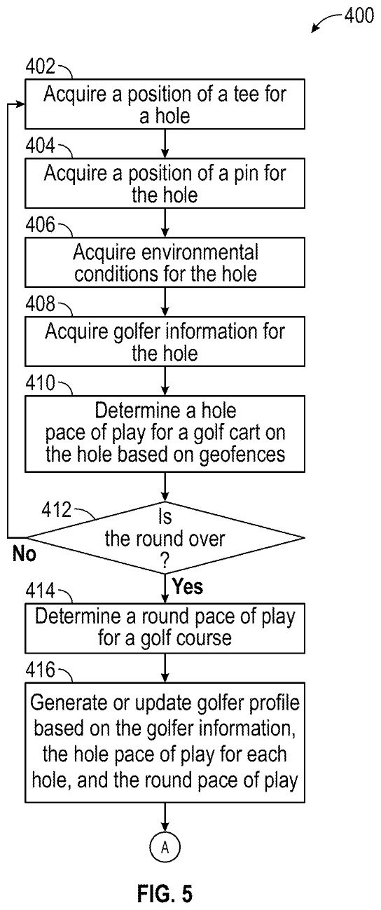

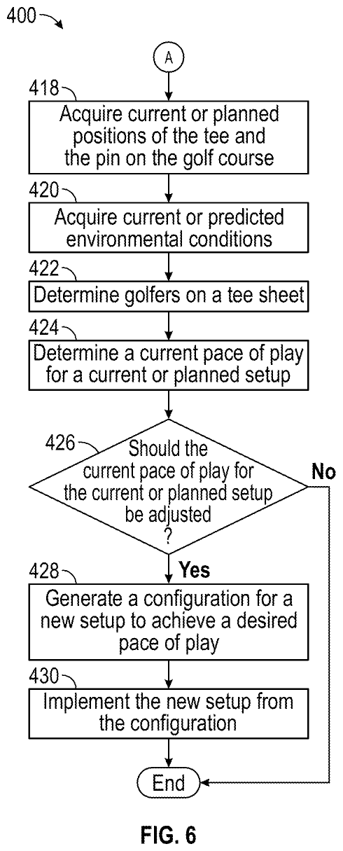

Referring now to FIGS. 5 and 6, a method 400 for generating a configuration for a setup (e.g., layout, etc.) of the golf course 300 to achieve a desired pace of play. The method 400 may be performed by the site monitoring and control system 200, the vehicle controller 100, and/or the remote systems 240.

At step 402, a control system (e.g., the site monitoring and control system 200, the vehicle controller 100, the remote systems 240, etc.) is configured to acquire (e.g., detect, record, collect, determine, etc.) a position (e.g., location, etc.) of a respective tee (e.g., the first tee 306, the second tee 322, etc.) for a respective hole. At step 404, the control system is configured to acquire a position of a respective pin (e.g., the first pin 318, the second pin 326, etc.) for the respective hole. Both the position of the respective pin for the respective hole and the position of the respective tee for the respective 302 become historical data that can later be accessed by the control system. The control system is configured to acquire the positions of the respective pin and the respective tee based on GPS data acquired by a GPS device (e.g., a user sensor 220, a hand-held TruPin GPS device offered by E-Z-GO® used by a groundskeeper of the golf course 300, a vehicle GPS of the vehicle 10, etc.). The acquired positions of the respective pin and the respective tee may be accurate within one yard or less of an actual location of the respective pin and the respective tee. The tee location may impact the pace of play because the tee location impacts the distance a golfer must drive the ball during a tee shot (e.g., a first shot of the hole, etc.). The tee shot is important for attempting to achieve maximum distance while also maintaining accuracy, and often sets up subsequent shots for the hole, which influences overall strategy and outcome of the hole. For example, a tee location where the golfer must drive the ball farther, or a tee location that requires the golfer to need more strokes to complete the hole will increase the total time and, therefore, slow the pace of play. The pin location impacts the pace of play because the pin location may alter the number of putts required for a golfer to complete the hole (e.g., more difficult pin positions lead to a higher number of putts and a slower pace of play). In some embodiments, step 402 and step 404 occur at the beginning of each day when the golf course 300 sets the locations of the first pin 318 and the first tee 306 to obtain an accurate recordation of the locations for that day of the first pin 318 and the first tee 306. In some embodiments, step 402 and/or step 404 occur multiple times throughout the day to maintain higher accuracy in positions (e.g., a new first pin must be excavated due to hole edge collapse in the first pin 318, etc.). In some embodiments, step 402 and/or step 404 occur less than once per day (e.g., the first pin 318 is moved every other day, so the first pin 318 position is only acquired every other day, etc.).

At step 406, the control system is configured to acquire one or more environmental conditions (e.g., one or more soil conditions, one or more precipitation levels, one or more humidity levels, one or more visibility levels, one or more air quality indexes, one or more wind speeds, one or more UV indexes, etc.) for the respective hole. The environmental conditions become a part of the historical data that can later be accessed by the control system. The environmental conditions can include current weather and weather forecasts that the control system may acquire from meteorological data databases (e.g., the National Oceanic and Atmospheric Administration National Weather Service, etc.) according to the position of the respective tee 06 and the position of the respective pin. In some embodiments, the environmental conditions are acquired from the sensors 90 (e.g., a temperature sensor to acquire current temperature information, a capacitive humidity sensor to acquire humidity levels, etc.). In some embodiments, the environmental conditions can include recorded measurements input to the control system from a vehicle operator via the operator interface 48 (e.g., the vehicle operator utilizes soil sensor to acquire soil conditions such as moisture or salinity, etc.).

At step 408, the control system is configured to acquire golfer information (e.g., name, gender, Official World Golf Rankings, World Amateur Golf Ranking, handicap, other golfer identifier(s), etc.) for the respective hole. The control system may record the golfer information to databases (e.g., the memory 254, the memory 264, etc.). The golfer information may become a part of the historical data that can later be accessed by the control system.

At step 410, the control system is configured to determine a pace of play for a golf cart at the respective hole (e.g., the first hole 302, etc.). The pace of play for the respective hole becomes a part of the historical data that can later be accessed by the control system. In general, pace of play monitoring and reporting includes the control system detecting or determining the location of the golf cart (e.g., the vehicle 10, etc.), and recording time stamps of when the golf cart enters and exits each of various geofences (e.g., the geofences 314). The differences between time stamps of entering and exiting the geofences are used to determine the pace of play for the respective hole (e.g., the difference between a timestamp of the vehicle 10 entering the tee geofence 314 and the timestamp of the vehicle 10 exiting the green geofence 314, etc.). The control system is configured to analyze timestamps of the golf cart entering and leaving the geofences 314 to determine the pace of play for the current hole. Pace of play monitoring and reporting is described in greater detail in U.S. patent application Ser. No. 18/406,566, filed Jan. 8, 2024, which is incorporated herein by reference in its entirety.

At step 412, the control system is configured to determine whether the round of play is over (e.g., based on a certain amount of time passed since a last timestamp was recorded, if the golf cart returns to a golf cart parking area, etc.). If the control system determines that the round is still ongoing, the control system is configured to repeat steps 402-410 for each subsequent hole of the golf course 300 (e.g., the second hole 304, a third hole, a fourth hole, etc.). If the control system determines that the round is over, the control system is configured to proceed to step 414. At step 414, the control system is configured to determine a round pace of play for the occupants of the golf cart on the golf course. The round pace of play becomes a part of the historical data that can later be accessed by the control system.

At step 416, the control system is configured to generate a golfer profile, or update the golfer profile if one already exists, based on the golfer information, the hole pace of play for each hole, and the round pace of play for the golf course. For example, the golfer information, the hole pace of play, and the round pace of play may be used by the control system to create golfer profiles for each golfer that, over time, helps generate a better understanding of how each golfer or type of golfer plays on the golf course. With such golfer profiles, tee-sheets for each day at the golf course can be dynamic based on a predicted pace of play for each of the players on the tee-sheet and better optimized (e.g., player group assignments more intelligently created, etc.) such that the pace of play is more consistent, bottlenecks are avoided, more rounds of golf can be played, and the golfers have a more enjoyable experience.

At step 418, the control system is configured to acquire current or planned positions of the tees and the pins for each of the holes of the golf course (e.g., at the start of each day, when the course is reconfigured, from the GPS device, via the user portal 230, etc.) to determine a current setup or planned setup of the golf course. At step 420, the control system is configured to acquire current or predicted environmental conditions (e.g., precipitation conditions for the one or more holes within the next 24 hours, temperature conditions for the one or more holes in a week, UV indexes for the one or more holes within the next 24 hours, etc.) for the dates and times that the current or planned setup of the golf course 300 is being planned for (e.g., predicted environmental conditions for a tournament a week in the future, etc.). Again, environmental conditions can include current weather and weather forecasts that the control system draws from meteorological data databases (e.g., the National Oceanic and Atmospheric Administration National Weather Service, etc.) according to the current positions of the tees and the holes. In some embodiments, the environmental conditions are acquired from the sensors 90 (e.g., a temperature sensor to acquire current temperature information, a capacitive humidity sensor to acquire humidity levels, a wind sensor to acquire windspeed and wind direction, etc.). In some embodiments, the environmental conditions can include recorded measurements input into the control system from a vehicle operator (e.g., the vehicle operator utilizes soil sensor to acquire soil conditions such as moisture or salinity, etc.).

At step 422, the control system is configured to determine which golfers are on a tee sheet and access the golfer profiles for such golfers. The tee-sheet data is for the date and the time the current or planned setup of the golf course 300 is being planned to be played. The control system is configured to use the tee-sheet data to identify which golfers are on the tee-sheet and to acquire information for each of the golfers. The golfer profiles provide information regarding hole pace of play and round pace of play for each of the golfers on the tee-sheet for past tee positions, past pin positions, past environmental conditions, etc.

At step 424, the control system is configured to determine a current pace of play for a current or planned setup (e.g., a hole setup, a setup for a plurality of holes, etc.) of the golf course. The current pace of play is an estimated pace of play for the golf course based on the golfers on the tee-sheet and their past history on the golf course, accounting for current environmental conditions and the current or planned setup of the golf course.

At step 426, the control system is configured to determine if the current pace of play for the current or planned setup of the golf course is desirable or needs to be adjusted (e.g., based on an operator input to the user portal 230 after receiving information for the current pace of play for the current or planned setup). For example, golf course managers may want the pace of play to be slower or faster based on certain events taking place at the golf course on a certain day or weekend (e.g., a tournament, open play, weather conditions, etc.). Accordingly, the golf course managers can provide an input to the control system (e.g., via the user portal 230) such that the control system provides recommended adjustments to the current or planned setup to achieve a desired pace of play for the golf course. By way of example, improving pace of play to increase the number of golfers on a course may lead to increased revenue and to happier golfers (e.g., golfers consistently struggling to make par may become unhappy with the golf course and not return, etc.) or may lead to the ability to accommodate a larger tournament. If the current pace of play is desirable, the control system is configured to end method 400. If the current pace of play is not desirable, the control system is configured to proceed to step 428.

At step 428, the control system is configured generate a configuration for a new setup of the golf course to achieve the desired pace of play (e.g., a fastest pace of play, etc.) based on to the historical conditions, current conditions, and/or the predicted conditions (e.g., according to the combination of one or more environmental conditions, golfer skill level, one or more pin locations, one or more tee locations, pace of play information, etc.). The control system predicts the pace of play for the new setup of the golf course (e.g., a predicted pace of play, etc.) and generates adjustments to the current setup to provide the new setup where the predicted pace of play is substantially equal to the desired pace of play. The configuration for the new setup of the golf course includes information on where a new one or more of the tee positions and a new one or more of the pin positions should be for each hole to achieve the desired pace of play. In some embodiments the control system 200 includes multiple different options of new tee positions and new pin positions for achieving the desired pace of play (e.g., three different layouts for the tee positions and the pin positions to achieve the desired pace of play, etc.).

In some embodiments the configuration for the setup of the golf course includes generating a new tee-sheet to achieve the predicted pace of play being equal to the desired pace of play. By way of example, the control system may be configured to re-order the golfers on the tee-sheet or alter the time spacing between golfers based on the historical data such that the tee-sheet is run through as efficiently as possible (e.g., a slow golfer does not hold up faster golfers, etc.). In some embodiments, the control system is configured to regenerate and alter a portion of the setup partway through a game or tournament (e.g., during a game or tournament the predicted pace of play is falling behind or ahead the desired pace of play, so the control system regenerates the setup for the holes that have not yet been played to account for the loss or gain in time, etc.). In some embodiments, the control system 200 also generates a second setup for the golf course to achieve the fastest pace of play. In some embodiments, the second setup is an alternate setup to achieve the desired pace of play.

At step 430, the new setup from the configuration is implemented. Step 430 includes arranging the pins and the tees on each of the holes to reflect the generated new setup. Step 430 can also include altering the tee-sheet to reflect a new tee-sheet that is optimized by the control system.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle controller 100, etc.) and the site monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A pace of play system for a golf course, the pace of play system comprising:
one or more processing circuits configured to:
acquire one or more current or planned tee positions for one or more tees associated with one or more holes of the golf course;
acquire one or more current or planned pin positions for one or more pins associated with the one or more holes; and
estimate a current pace of play for a current setup of the golf course based on the one or more current or planned tee positions and the one or more current or planned pin positions.

2. The pace of play system of claim 1, wherein the one or more current or planned tee positions and the one or more current or planned pin positions are provided by one or more GPS devices positioned or positionable proximate the one or more tees and the one or more pins.

3. The pace of play system of claim 1, wherein the one or more current or planned tee positions and the one or more current or planned pin positions are provided through a user portal accessible via a user computing device.

4. The pace of play system of claim 1, wherein the one or more processing circuits are configured to:
acquire a desired pace of play for the golf course; and
generate a new setup for the golf course to substantially provide the desired pace of play.

5. The pace of play system of claim 4, wherein the one or more processing circuits are configured to provide a user portal on a user computing device that provides the current pace of play and facilitates a user entering the desired pace of play.

6. The pace of play system of claim 4, wherein the desired pace of play is a fastest pace of play for the golf course.

7. The pace of play system of claim 4, wherein the one or more processing circuits are configured to generate the new setup by at least one of:
providing a new tee position for at least one of the one or more tees for the new setup to achieve the desired pace of play; or
providing a new pin position for at least one of the one or more pins to achieve the desired pace of play.

8. The pace of play system of claim 4, wherein the new setup is based on a play history of golfers included on an upcoming tee-sheet for the golf course and past setups of the golf course.

9. The pace of play system of claim 8, wherein the new setup is based on past environmental conditions for the past setups and current or predicted environmental conditions during play on the new setup.

10. The pace of play system of claim 4, wherein the new setup of the golf course is a first setup, wherein the one or more processing circuits are configured to generate a second setup of the golf course to substantially provide the desired pace of play, and wherein the first setup is different than the first setup.

11. The pace of play system of claim 1, wherein the current pace of play is estimated based on past setups of the golf course.

12. The pace of play system of claim 11, wherein the current pace of play is estimated based on a play history of golfers included on an upcoming tee-sheet for the golf course.

13. The pace of play system of claim 12, wherein the current pace of play is estimated based on past environmental conditions for the past setups and current or predicted environmental conditions during play of the upcoming tee-sheet.

14. A pace of play system for a golf course, the pace of play system comprising:
one or more processing circuits configured to:
acquire one or more current or planned tee positions for one or more tees associated with one or more holes of the golf course;
acquire one or more current or planned positions for one or more pins associated with the one or more holes;
estimate a current pace of play for a current setup of the golf course based on the one or more current or planned tee positions and the one or more current or planned pin positions;
acquire a desired pace of play for the golf course; and
generate a new setup for the golf course to substantially provide the desired pace of play by providing at least one of (a) a new tee position for at least one of the one or more tees or (b) a new pin position for at least one of the one or more pins to achieve the desired pace of play;
wherein the new setup is based on at least one of (a) a play history of golfers included on an upcoming tee-sheet for the golf course, (b) past setups of the golf course, (c) past environmental conditions for the past setups, or (d) current or predicted environmental conditions during play on the new setup.

15. The pace of play system of claim 14, wherein the new setup is based on at least two of (a) the play history of golfers included on the upcoming tee-sheet for the golf course, (b) the past setups of the golf course, (c) the past environmental conditions for the past setups, or (d) the current or predicted environmental conditions during play on the new setup.

16. The pace of play system of claim 14, wherein the new setup is based on (a) the play history of golfers included on the upcoming tee-sheet for the golf course, (b) the past setups of the golf course, (c) the past environmental conditions for the past setups, and (d) the current or predicted environmental conditions during play on the new setup.

17. A pace of play system for a golf course, the pace of play system comprising:
one or more processing circuits configured to:
acquire one or more current or planned tee positions for one or more tees associated with one or more holes of the golf course;
acquire one or more current or planned pin positions for one or more pins associated with the one or more holes; and
estimate a current pace of play for a current setup of the golf course based on the one or more current or planned tee positions, the one or more current or planned pin positions, past setups of the golf course, past environmental conditions for the past setups, and current or predicted environmental conditions during play on the current setup.

18. The pace of play system of claim 17, wherein the one or more processing circuits are configured to:
acquire a desired pace of play for the golf course; and
generate a new setup for the golf course to substantially provide the desired pace of play.

19. The pace of play system of claim 18, wherein the new setup is based on a play history of golfers included on an upcoming tee-sheet for the golf course.

20. The pace of play system of claim 17, wherein the current pace of play is estimated based on a play history of golfers included on an upcoming tee-sheet for the golf course.
